(19) United States
(12) Patent Application Publication
(10) Pub. No.: US 2005/0265812 A1
(43) Pub. Date: Dec. 1, 2005

(54) Load port for clean system

(75) Inventors: Hitoshi Suzuki, Tokyo (JP); Tsutomu Okabe, Tokyo (JP); Hiroshi Igarashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/137,658

(22) Filed: May 26, 2005

(30) Foreign Application Priority Data
May 28, 2004 (JP) 2004-159199

(51) Int. Cl. B65G 65/34

(52) U.S. Cl. 414/411

(57) ABSTRACT

The present invention is aimed to reduce a possibility that clean space at the so-called door being opened in the FIMS system is polluted. In order to achieve the object concerned, as a driving mechanism for driving a load port door in the FIMS system, mechanisms different in driving speed are used between during the early stage of driving and any other state than it. Particularly, during the early stage of driving, it is made possible to drive the door at exceedingly low speed, and after the door is opened by a predetermined amount, the door will be driven at high speed that has been usually controlled.

### BACKGROUND OF THE INVENTION

1. Field of the Invention

The present invention relates to a so-called load port for forming, in a manufacturing process for an object such as semiconductors, flat-panel display panels and optical disks, in which under a highly clean environment their process is performed, clean space for carrying the object or the like in to or out of an object housing container for housing the object or the like, and more particularly to a port door for opening or closing a lid for closing an aperture in the main body of the housing container concerned as well as opening or closing the clean space.

2. Related Background Art

In the past, the semiconductor manufacturing process was performed within a so-called clean room obtained by making the interior of a chamber for handling semiconductor wafers highly clean. However, in terms of the tendency of wafer size toward bulkiness and reduction in cost required for management of the clean room, in recent years, there has been adopted a technique for holding only the interior of a processing apparatus, a pod (wafer housing container) and microspace in which a substrate is delivered from the pod to the processing apparatus in a highly clean state.

The pod is comprised of: a main body portion having a substantially cube shape having a shelf capable of holding a plurality of wafers in a state of placing them in parallel and at intervals within, and an aperture to be used for loading and unloading wafers on one surface thereof; and a lid for closing the aperture. The pod, in which the formation surface of this aperture has been arranged on one side surface (the front side toward the microspace), not downward of the pod vertically is collectively called FOUP (front-opening unified pod), and the present invention mainly targets the structure using this FOUP.

The above-described microspace has: a first aperture on opposite side to the pot aperture; a door for closing the first aperture; a second aperture provided on the semiconductor processing apparatus side; and a carrying robot for entering the interior of the pod through the first aperture for holding a wafer and passing through the second aperture for conveying a wafer to the processing apparatus side. Structure for constituting the microspace is to have a placement base for supporting the pod such that the pot aperture is correctly opposite to the door front at the same time.

On the upper surface of the placement base, there are arranged a positioning pin for being fitted to a positioning hole provided on the lower surface of the pod for defining a placement position of the pod; and a clamp unit for fixing the pod to the placement base by engaging with a portion to be clamped, provided on the lower surface of the pod. Usually, the placement base is capable of moving to and from over a predetermined distance toward a direction of the door. When carrying a wafer within the pod to the processing apparatus, the pod is caused to move until the pod lid comes into contact with the door in a state in which the pod has been placed, and after contact between the two, the lid is removed from the pod aperture by the door. By performing these operations, the interior of the pod comes to communicate to that of the processing apparatus via the microspace, and thereafter, the wafer placement operation will be repeatedly performed. As shown in U.S. Pat. Nos. 6,501,070B1 and 6,281,516B1, Japanese Patent Application Laid-Open No. 2003-45933 or No. 2002-353293, including walls and the like for constituting a part of the microspace in which this placement base, the door, the first aperture, the door opening and closing mechanism, and the first aperture have been constituted, these are collectively called FIMS (front-opening interface mechanical standard) system.

The interior of the microspace in the above-described FOUP and FIMS is generally filled with gas different from the air existing around it, and held at pressure different from the surrounding pressure (atmospheric pressure). This is to prevent pollution of wafers due to organic matter, moisture content and the like that exist in the atmosphere, and usually this state has been obtained by leading high-purity nitrogen to these space at a predetermined pressure. Also, since this predetermined pressure forms a gas flow toward ambient space from internal space to prevent dust and the like from the ambient space toward the internal space from flowing in, the predetermined pressure is often set to be higher than the ambient pressure.

As regards pressure in the interior of the microspace in such FOUP and FIMS, there has usually been provided only a mechanism for keeping it constant in terms of making equipment unsophisticated. Therefore, when the door removes the FOUP's lid from its main body, two or three space in which a pressure difference exists are to be connected together in one stroke, resulting in an abrupt air flow between these space. Such air flow may possibly cause occurrence of dust and the like, and inclusions into these space for deteriorating cleanliness of these space. In other words, by opening the door, there exists a possibility that dust and the like occur to pollute the clean space. Also, as the wafer size becomes larger in recent years, capacity of FOUP and the above-described microspace has been increased, and accordingly, the possibility of occurrence of the pollution and the like is considered to increase.

### SUMMARY OF THE INVENTION

The present invention has been achieved in view of the above-described state of affairs, and is aimed to provide the FOUP for reducing the possibility of pollution in the clean space that occurs as the door is opened, and a door opening mechanism in the FOUP, that is, a FIMS system.

In order to solve the above-described problem, according to the present invention there is provided a load port for detaching a lid from and attaching to a pod having a main body portion which places an aperture and an object to be housed in parallel in a predetermined direction for housing, and the lid which is separate-able from the main body portion and blocks the aperture, comprising: a chamber having a first aperture opposite to the aperture; a door for closing the first aperture, capable of holding the lid; and a door arm for supporting the door at its one end, being coupled to the drive unit at the other end, and being, at the intermediate portion, rotatively supported by a fixing member, wherein the drive unit drives the door arm at a predetermined speed during the early stage of driving and drives the door arm at speed faster than the predetermined speed with the exception of during the early stage of driving.

In this respect, as the drive unit, various forms are applicable, but the drive unit is desirably a two-step cylinder in the present invention. In this case, the two-step cylinder has: a cylindrical cylinder chamber; a piston having a disk-shape coaxial to the cylinder chamber, arranged within the cylinder chamber, for separating the cylinder chamber into a rod-side cylinder chamber and a head-side cylinder chamber; a through-hole coaxial to the cylinder chamber and having a smaller inner diameter than that of the cylinder chamber, and a rod-side port, both of which communicate the rod-side cylinder chamber to the outside of the two-step cylinder; a cylindrical auxiliary chamber coaxial to the cylinder chamber and having a smaller inner diameter than that of the cylinder chamber, and a bypass path provided at a different position from the auxiliary chamber and having a drawing portion therein, both of which communicating to an end portion different from a side of the head-side cylinder chamber at which the piston is arranged, and communicating to a head-side port for communicating the head-side cylinder chamber to the outside of the two-step cylinder; a cylinder rod coaxial to the piston, one end of which is supported by the piston, the other end of which extends as far as the outside of the two-step cylinder via the through-hole; a head portion coaxial to the piston, one end of which is supported on the auxiliary chamber-side surface in the piston, having an enlarged-diameter portion having a smaller outer diameter than the inner diameter of the auxiliary chamber; and a head-side packing fixed to the inner peripheral surface of the auxiliary chamber in a predetermined position the auxiliary chamber in an axial direction, wherein the outer peripheral surface of the enlarged-diameter portion is slidable in a close contact state with the head-side packing, and in the close contact state, the head-side cylinder chamber communicates to the head-side port via only the bypass path. The above-described structure is desirably used.

Also, in order to solve the above-described problem, according to the present invention there is provided a method for opening the first aperture by the door in a load port for detaching a lid from a pod having a main body portion which places an aperture and an object to be housed in parallel in a predetermined direction for housing, and the lid which is separate-able from the main body portion and blocks the aperture, the load port having a chamber having the first aperture opposite to the aperture; a door for closing the first aperture and capable of holding the lid; and a door arm for supporting the door at its one end, being coupled to the drive unit at the other end, and being, at the intermediate portion, rotatively supported by a fixing member, wherein during the early stage whereat the door opens the first aperture, the door is driven by the drive unit at a predetermined speed; after the door is spaced apart by a first predetermined amount from the first aperture, the door is driven by the drive unit at speed faster than the predetermined speed; after the door is spaced apart by a second predetermined amount from the first aperture, the opening of the door by the drive unit is stopped; and the door and the drive unit are placed in a body at an interval from the first aperture.

According to the present invention, by lowering the door opening speed, it becomes possible to eliminate abrupt pressure fluctuation in each space to thereby restrain dust from occurring. Also, as regards internal pressure fluctuation in each space, only during the early stage of the door opening, whereat the door opening operation has an extreme effect, the speed is reduced, and after the intermediate stage whereat the effect becomes insignificant, the speed is increased. In other words, the speed is not lowered in the entire opening and closing region, but the operation is performed at low speed only in a part of the region concerned, and extension in time period required for opening the door is restrained. Accordingly, without extending a conventional time period required for opening the door much, it becomes possible to restrain occurrence of dust and the like, and to reduce the possibility of pollution in the clean space due to these.

Other objects and aspects of the invention will become apparent from the following description of the embodiment with reference to the accompanying drawings.

### BRIEF DESCRIPTION OF THE DRAWINGS

FIG. 1 is a side sectional view showing schematic structure of a principal part of a load port according to the present invention;

FIG. 2 is a schematic sectional view of a two-step cylinder shown in FIG. 1;

FIG. 3 is a schematic sectional view of a two-step cylinder shown in FIG. 1;

FIG. 4 is a schematic sectional view of a two-step cylinder shown in FIG. 1;

FIG. 5 is a schematic sectional view of a two-step cylinder shown in FIG. 1;

FIG. 6 is a schematic sectional view of a two-step cylinder shown in FIG. 1;

FIG. 7 is a side view schematically showing portions relating to the mechanism concerned in a FIMS system using the load port according to the present invention; and

FIG. 8 is a view showing schematic structure of a semiconductor processing apparatus to which the FIMS system shown in FIG. 7 has been applied.

### DESCRIPTION OF THE PREFERRED EMBODIMENTS

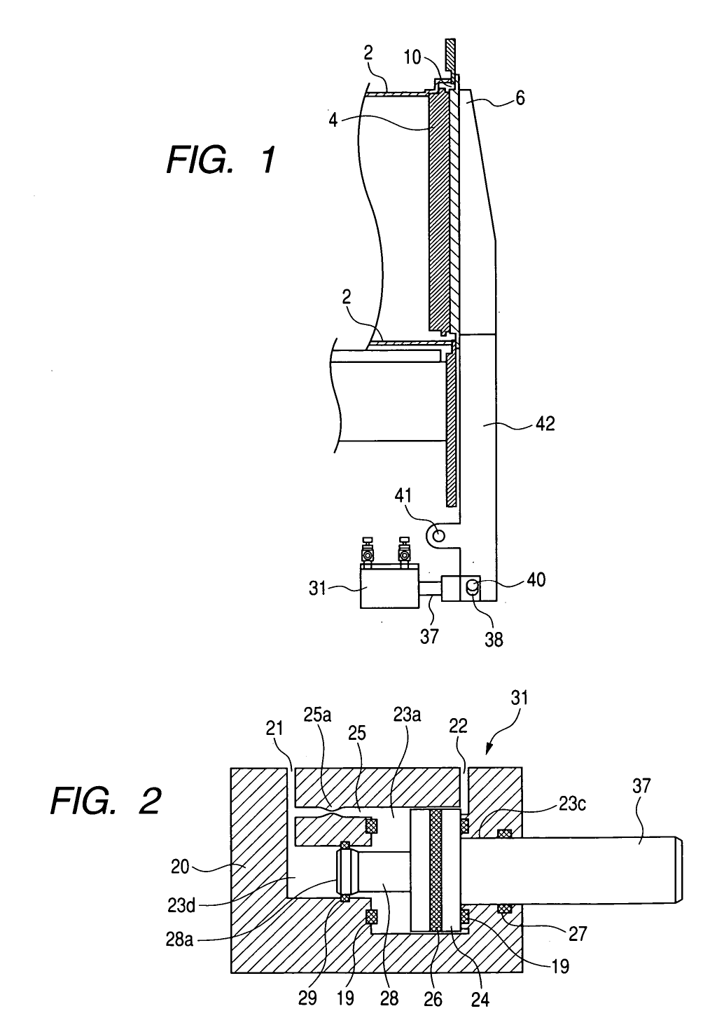

Hereinafter, with reference to the drawings, the description will be made of a load port according to an embodiment of the present invention. FIG. 1 is a side view showing a part of FOUP, a door in a FIMS system and a principal part of its open and close mechanism. Also, FIG. 2 shows the schematic structure of a cross section of a two-step cylinder, which is a drive unit for actually opening and closing the door in the system concerned. In more detail, FIG. 1 shows that the first aperture of the load port has been closed by the door and a state in which the FOUP in a lid-closed state has come into contact with the door.

In FIG. 1, the main body 2 of FOUP has its aperture closed by a lid 4. A door 6 is supported by a door arm 42, and a first aperture 10 in the FIMS system has been closed in the state shown in FIG. 1. On a door 6-side surface of the lid 4 and the lid 4-side surface of the door 6, there has been arranged a restraining mechanism (not shown) for shifting these to a restrained state or a non-restrained state. A door arm 42 is connected to the door 6 at its upper end for supporting it. At the same time, the door arm 42 is at its lower end coupled to a two-step cylinder 31 to be described later through a cylinder rod 37. The coupling is performed by a pin 40 laid at the lower end of the door arm 42 being inserted into a slotted hole 38 provided at the tip of the cylinder rod 37.

The door arm 42 is, further at its intermediate portion, fixed by a fixing member 39 to be described later in a pivotable state around a fulcrum 41 via a bearing and the like (not shown). The cylinder rod 37 expands and contracts by means of the two-step cylinder 31, whereby the door arm 42 is pivoted around the fulcrum 41 via the pin 40. The shape of the slotted hole 38 into which the pin 40 is inserted is made into an adequate one, whereby this pivoting operation has been made smooth. In the present example, the two-step cylinder 31 has been arranged on the same side as the fulcrum 41 toward the door arm 42. In other words, when the cylinder rod 37 expands extremely, the door 6 closes the first aperture 10, and the door 6 opens the first aperture 10 in response to the contraction of the cylinder rod 37.

In this respect, a stroke of the cylinder rod 37 can have such a size that the lid 4 held by the door 6 becomes movable as far as a position whereat the lid 4 does not interfere with a wall surface for forming the first aperture 10. The two-step cylinder 31, the cylinder rod 37, the door arm 42 and the door 6 are supported by the fixing member 39 as shown in an example to be described later. The fixing member 39 has been fixed to a moving portion 56, and the moving portion 56 is capable of moving in the up-and-down direction (extending direction of a support shaft 57) by the support shaft 57. In a stage where the two-step cylinder 31 causes the door 6 and the lid 4 to be spaced apart from the aperture of the FOUP 2 by a predetermined amount, the moving portion 56 moves downward, whereby the first aperture 10 enters a full-opened state.

Next, with reference to FIG. 2 showing the sectional structure, the description will be made of the structure of the two-step cylinder 31 to be used in an embodiment of the present invention. The two-step cylinder 31 has a cylinder body 20 in which a head-side port 21, a rod-side port 22 and a cylinder chamber 23 capable of supplying and discharging pressure fluid through these ports have been formed therein; and a piston 24 to be housed within the cylinder chamber 23. The cylinder chamber 23 is cylindrical space formed coaxially to the shaft of the cylinder rod 37, and communicates to a through-hole 23c through which the cylinder rod 37 penetrates.

The through-hole 23c has been set to a smaller inner diameter than that of the cylinder chamber 23, and causes the cylinder chamber 23 to communicate to the outside of the two-step cylinder 31. Also, the cylinder chamber 23 is, at an end surface at a side opposite to the cylinder rod side, coaxial to the cylinder chamber 23, and communicates to an auxiliary chamber 23d of a cylindrical shape, having a smaller inner diameter than that of the cylinder chamber 23. Also, a bypass path 25 arranged at a different position from the auxiliary chamber 23d at the same time, having a further smaller inner diameter than that of the auxiliary chamber 23d also communicates to the cylinder rod-side end surface. The bypass path 25 has a drawing portion 25a having a smaller inner diameter in the course. A flow rate of the pressure fluid for passing through the bypass path 25 is determined in accordance with the inner diameter of this drawing portion 25a.

The auxiliary chamber 23d and the bypass path 25 further communicate to the head-side port 21. The piston 24 has a circular shape having an outer diameter slightly smaller than the inner diameter of the cylinder chamber 23, and on the side surface thereof, there is arranged a cylinder packing 26 in tight contact with the inner wall of the cylinder chamber so as to be able to slide thereon. By the piston 24 and the cylinder packing 26, the cylinder chamber 23 is divided into a head-side cylinder chamber 23a and a rod-side cylinder chamber 23b. The head-side port 21 communicates to the head-side cylinder chamber 23a via the auxiliary chamber 23d and the bypass path 25, and the rod-side port 22 communicates to the rod-side cylinder chamber 23b. Also, around a coupled portion to the auxiliary chamber 23d at the head-side end surface of the cylinder chamber 23, and around a coupled portion to the through-hole 23c at the rod-side end surface, there is arranged a cushion 19 respectively. The cushion 19 prevents the piston 24 from colliding with the end surface of the cylinder chamber 23, and defines an operating range of the cylinder rod 37.

On a rod-side surface of the disk-shaped piston 24, the cylinder rod 37 is connected such that it becomes coaxial to this disk, and on the inner peripheral surface of the through-hole 23c through which this cylinder rod 37 penetrates, rod-side packing 27 is arranged in order to keep the cylinder chamber airtight. The rod-side packing 27 is brought into tight contact with the outer peripheral surface of the cylinder rod 37 slidably for supporting to keep the rod-side cylinder chamber 23b in an enclosed state. Also, on a head-side surface of the piston 24, there is provided a cylindrical head 28 coaxial to this disk. The head 28 has a sufficiently smaller outer diameter than the inner diameter of the auxiliary chamber 23d, and has, at an end portion opposite to a side continuing to the piston 24, an enlarged diameter portion 28a, the diameter of which has been enlarged, having a predetermined length.

At a predetermined position on the inner peripheral surface of the auxiliary chamber 23d, head-side packing 29 has been fixed. The outer diameter of the enlarged-diameter portion 28a is brought into tight contact with this head-side packing 29, and at the same time, in a region in which no packing 29 exists, it has been set such that there is a sufficient clearance with the inner peripheral surface of the auxiliary chamber 23d. In other words, in a region in which the enlarged-diameter portion 28a is brought into tight contact with this head-side packing 29, the head-side cylinder chamber 23a is coupled to the head-side port 21 via only the bypass path 25. Therefore, when the enlarged-diameter portion 28a is brought into tight contact with the head-side packing 29, pressure fluid from the head-side cylinder chamber 23a is discharged via only the drawing portion 25a. Also, with the movement of the piston 24 toward the head side, the head 28 moves, and after this tight contact state is released, the pressure fluid is mainly shifted via space between the outer peripheral surface of the head 28 and the inner peripheral surface of the auxiliary chamber 23d.

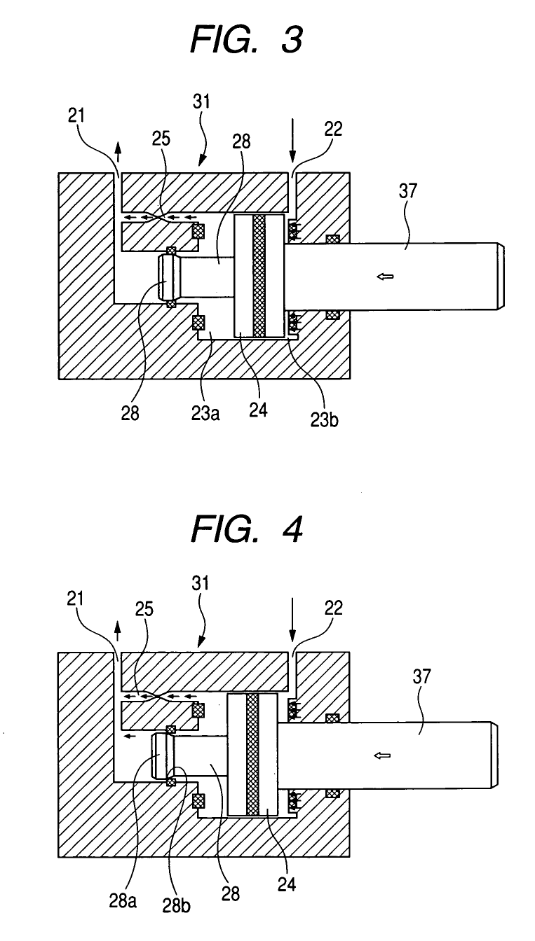

Next, the description will be made of the operation of the two-step cylinder 31. FIGS. 3 to 6 show each stage between a state in which the cylinder rod 37 shown in FIG. 2 extends extremely and a state in which the cylinder rod 37 contracts extremely, respectively. Hereinafter, the description will be made of each stage individually. First, toward the rod-side cylinder chamber 23b in the two-step cylinder 31 in the state shown in FIG. 2, the pressure fluid is supplied from a pressure fluid source (not shown) maintained at a predetermined pressure. As the pressure fluid is supplied, pressure within the rod-side cylinder chamber 23b is increased, and after it balances with the pressure within head-side cylinder chamber 26a, a force toward the head side (left direction in the figure) is further given to the piston 24. The operation of this force causes the piston 24 to apply a compressive force to the pressure fluid within the head-side cylinder chamber 23a.

By the application of the compressive force, the pressure fluid within the head-side cylinder chamber 23a is discharged to the head-side port 21 via the bypass path 25. Since, however, the inner diameter of the drawing portion 25a has been set to slight size, the discharge speed of the pressure fluid is low, and the pressure within the head-side cylinder chamber 23a gradually rises while keeping it's balance with the pressure within the rod-side cylinder chamber 23b. In this state, as shown in FIG. 3, the piston 24 starts to move slowly in accordance with the discharge speed of this pressure fluid.

When the piston 24 moves as far as the position shown in FIG. 4, the tight contact state between the enlarged-diameter portion 28a and the head-side packing 29 is released. In the present embodiment, in the coupled portion between the enlarged-diameter portion 28a and the other part of the head portion 28, there is provided a tapered portion the outer diameter of which continuously changes. After the tight contact state is released, therefore, a flow channel, along which the pressure fluid within the head-side cylinder chamber 3a reaches the head-side port 21, will not have a clearance between the outer peripheral surface of a head portion 28 and the inner peripheral surface of the auxiliary chamber 23d immediately, but the clearance will gradually become larger. From a stage whereat the size of the clearance exceeds the size of the flow channel in the drawing portion 25a, in the discharge flow channel of the pressure fluid, the clearance concerned becomes the main body.

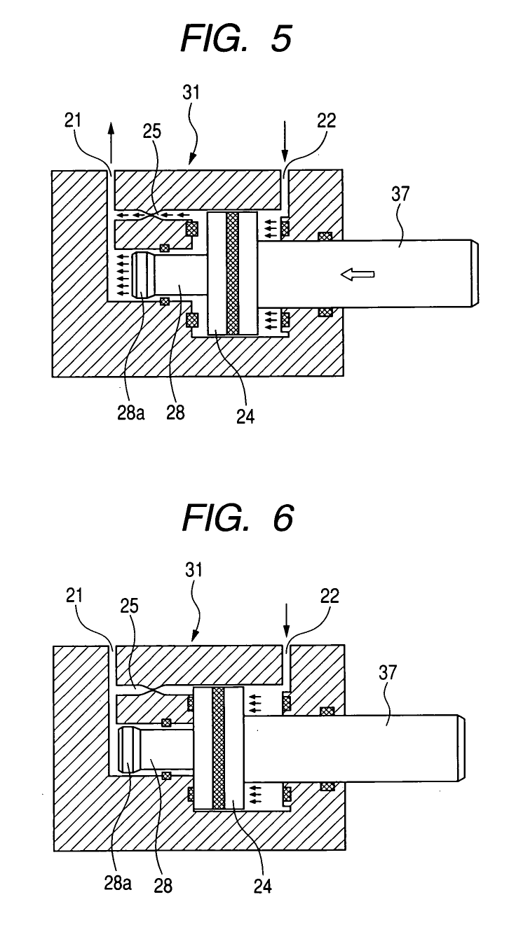

After the clearance reaches a predetermined size as shown in FIG. 5, the discharge flow channel of the pressure fluid comes to have fixed and sufficient size. Therefore, the piston 24 moves to the head side at a predetermined speed responsive to a feed rate of the pressure fluid from the rod-side port 22. This movement will be continued until the head-side end surface of the piston 24 comes into contact with a cushion 19 arranged on the head-side end surface of the cylinder chamber 23. After the piston 24 comes into contact with the cushion 19, since the cylinder rod 37 stops with stability, after a predetermined amount of pressure fluid is further supplied to the rod-side cylinder chamber 23b, the supply of the pressure fluid will be stopped.

As described above, according to the two-step cylinder of the present embodiment, during the early time period whereat the pressure fluid has been supplied from the rod-side port, the cylinder rod 37 starts its contracting operation slowly in accordance with the diameter of the drawing portion 25a, the internal pressure of the head-side cylinder chamber 23a and the supply speed of the pressure fluid. After the cylinder rod 37 contracts a distance responsive to the length of the enlarged-diameter portion 28a, the cylinder rod 37 changes its speed to speed responsive to the supply speed of the pressure fluid to further perform the contracting operation. In this respect, when the drain route of the pressure fluid changes, the internal pressure within the head-side cylinder chamber 23a changes significantly, whereby the speed of the contracting operation of the cylinder rod 37 may possibly vary. In the present embodiment, the inclination of the tapered portion 28b is made into an adequate one, whereby the speed change of the cylinder rod 37 when shifting from the low-speed operation to the high-speed operation has been restrained to fluctuation within a continuous and predetermined range.

Through the use of the above-described two-step cylinder 31, the door 6 is opened and closed, whereby the door 6 is driven as described below in response to the operation of the cylinder rod 37 in the two-step cylinder 31. In other words, when opening the first aperture 10 by driving the door 6, the two-step cylinder 31 is first in the state shown in FIG. 3 at the early stage of opening. Accordingly, the cylinder rod 37 starts a slow contracting operation, and the door 6 starts the opening operation at low speed by the door arm 42 being towed by the rod. The moving speed of this door 6 is determined at a predetermined speed by the inner diameter of the drawing portion 25a in the bypass path 25. As the opening operation of the door 6 advances, the cylinder rod 37 further contracts and reaches the state shown in FIG. 5 through the state shown in FIG. 4.

In the state shown in FIG. 4, the door 6 enters a state in which it is spaced a first predetermined amount apart from the first aperture 10. With further contraction of the cylinder rod 37, the opening operation of the door 6 also shifts from the driving at low speed that is predetermined speed at the early stage to high-speed driving that is faster speed. When the contracting operation of the cylinder rod 37 stops in the state shown in FIG. 6, the opening operation of the door 6 due to the two-step cylinder 31 reaches a second predetermined position to stop the driving, and successively, these configurations lower.

The two-step cylinder 31 described above is used as the drive unit for the door 6, whereby it becomes possible to start the opening operation at remarkably slow low speed at the early stage of opening whereat the pressure fluctuation in the related space occurs remarkably abruptly due to the opening operation of the door 6 and the lid 4. Accordingly, it becomes possible to restrain air flow associated with the pressure fluctuation from occurring, and to prevent the clean space from being polluted by inclusions and the like of the air flow concerned. Also, an interval in which driving at low speed is performed is determined to be an adequate one on the basis of the length of the enlarged diameter portion 28a, whereby it becomes possible to perform a further door opening operation by driving at a predetermined high speed after the pressure fluctuation in each space is substantially eliminated. Accordingly, it becomes possible to restrain a time period required for the opening operation of the door and the lid from extending, and to eliminate any extension of the time period in the actual opening operation.

In this respect, in the present embodiment, as a drive unit having the most simple and effective structure, the two-step cylinder is to be used. However, it is made possible to drive the door in the FIMS system at different speeds—low speed and high speed, whereby it is possible to obtain the effect due to the present invention. Accordingly, the two-step cylinder may be replaced with an electrically-driven drive unit using a motor or the like, a drive unit using a cam, structure in which introduction routes of a pressure medium have been arranged in two systems for low speed and for high speed using ordinary cylinders, or a two-step cylinder having another structure or the like.

However, these structures have the following advantages and defects. For example, in the case of the electrically-driven drive unit, it is excellent in a degree of freedom in changing the setting such as the driving interval at low speed being arbitrarily changeable. After the driving condition is determined to some degree, however, it becomes obviously over-specification in terms of cost, reliability and the like, and it is judged not to be practical. The driving mechanism using the cam is not easy to change the setting, but has drawbacks that the number of parts will be increased, and the mechanism will become complicated. It cannot be said to be practical also at this point.

A system in which two systems of introduction routes of pressure fluid are arranged and these are switched through the use of a magnet valve for driving at low speed and at high speed is also conceivable. This system can be implemented by using the structure which has been conventionally used as it is, but since two systems of pressure sources are required from a utility viewpoint, installation of a new equipment is required. Also, in the case of the system concerned, it is difficult to strictly control a switching portion between the low-speed driving region and the high-speed driving region, and it can be said to be an improper system in controlling the speed more strictly. Although it is also possible to use a two-step cylinder having another structure, the two-step cylinder is usually complicated in structure, and a stable operation for an extended period may be difficult depending upon the use environment. The two-step cylinder shown in the present embodiment is simple in structure, is unaffected by the use environment and the like, and is considered to be able to provide a stable operation for an extended period.

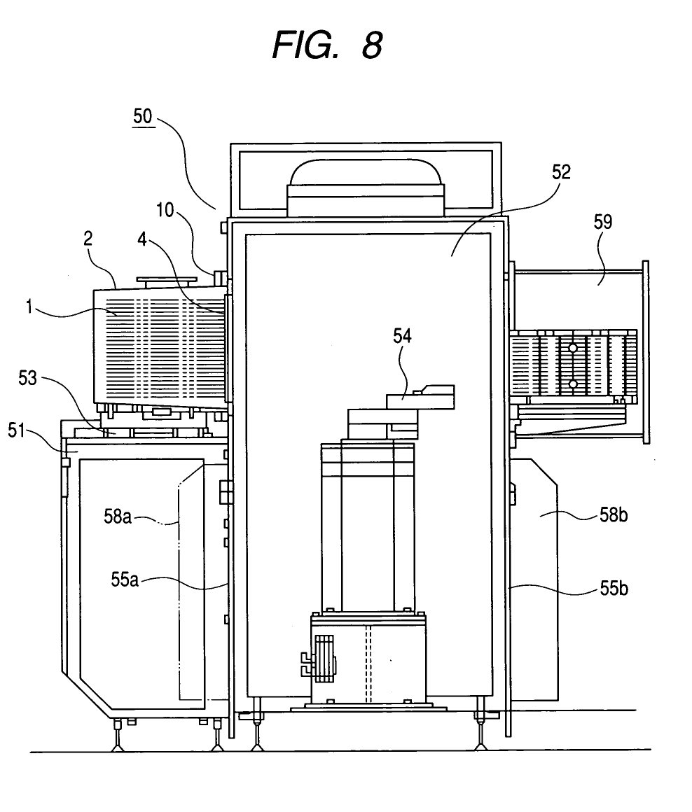

Next, hereinafter, the description will be made of a case where a load port for FIMS system according to the present invention has been used for an actual FIMS system as an example of the present invention. Hereinafter, a semiconductor processing apparatus and the like corresponding to the so-called mini-environment system, to which the FIMS system to be actually used has been installed, will be briefly described. FIG. 8 shows a semiconductor wafer processing apparatus 50 as a whole. The semiconductor wafer processing apparatus 50 is mainly comprised of: a load port portion 51; a conveying chamber 52; and a processing chamber 59. Their respective joined portions are partitioned by a load port-side partition 55a and a cover 58a, and a processing chamber-side partition 55b and a cover 58b. Since in the conveying chamber 52 in the semiconductor wafer processing apparatus 50, dust is discharged to maintain high cleanliness, air flow is generated from above in the conveying chamber 52 downward by a fan (not shown) provided in the upper part thereof. Thereby, dust is to be always discharged downward.

On a load port portion 51, a pot which is a container for storage for silicon wafer and the like (hereinafter, referred to as wafer merely) is provided on a stand 53. As described previously, the interior of the conveying chamber 52 has been maintained at high cleanliness in order to process a wafer 1, and further a robot arm 54 has been provided inside. By means of this robot arm 54, a wafer is transferred between within the pod 2 and within the processing chamber 59. In the processing chamber 59, various mechanisms for implementing processing such as thin-film formation and thin-film processing are included, but since these structure have nothing direct to do with the present invention, description thereof will be omitted here.

The pod has space for housing wafers 1, which are objects to be processed, within, and has a box-shaped main body portion 2 having an aperture on any surface thereof, and a lid 4 for closing the aperture. Within the main body portion 2, there is arranged a shelf having a plurality of steps for laying wafers 1 one upon another in one direction, and each of the wafers 1 to be placed here is housed within the pod at regular intervals. In this respect, in the example shown here, wafers 1 are laid one upon another in a vertical direction. On the load port portion 51 side of the conveying chamber 52, there is provided a first aperture 10. When it has been arranged on the load port portion 51, the first aperture 10 is arranged at a position opposite to the pod aperture such that the pod is positioned close to the first aperture 10. Also, in the conveying chamber 52, the above-described door open-close mechanism is provided near the aperture 10 in the inside.

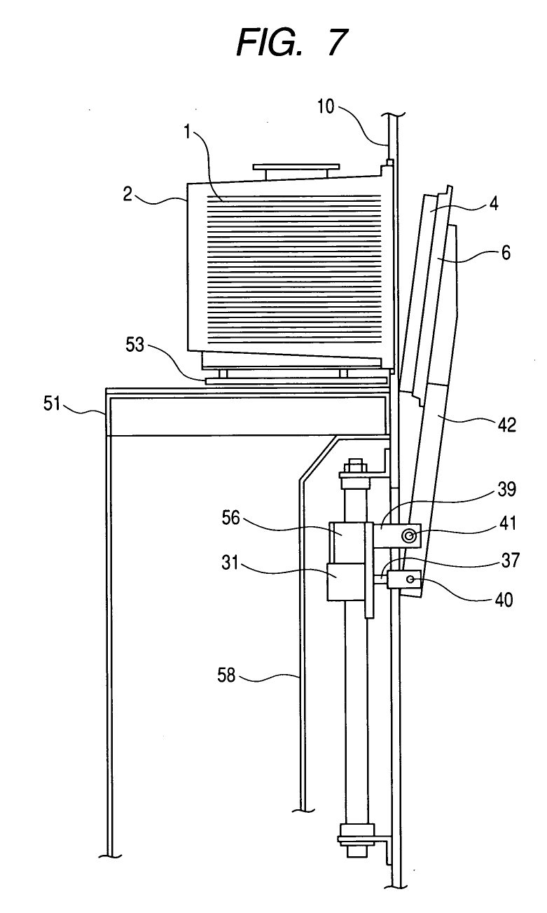

FIG. 7 is an enlarged side sectional view showing a portion relating to the door open-close mechanism in the load port. More specifically, it schematically shows a side sectional view in a state in which the lid 4 has been removed from the pod through the use of the door open-close mechanism. The door open-close mechanism has, as described above, the door 6 and the door arm 42. The door 6 is pivotally coupled to one end of the door arm 42. The other end of the door arm 42 is supported on the tip portion of the cylinder rod 37, which is a part of an air driven type two-step cylinder 31, via the pin 40 rotatively with respect to the pin 40.

Between the one end and the other end of the door arm 42, there is provided a through-hole. The through-hole and a hole in a fixing member 39 fixed to a moving portion 56 for causing the door open-close mechanism to ascend and descend are penetrated by a pin (not shown), whereby a fulcrum 41 is constituted. Accordingly, in response to extension and contraction of the rod 37 by driving the two-step cylinder 31, the door arm 42 becomes pivotable around the fulcrum 41.

When processing the wafer 1 with these structures, the pod 1 is first arranged on a stand 53 such that it is positioned close to the aperture 10 of the conveying chamber, and the lid 4 is held by the door 6. Thus, when the rod of the cylinder 31 is contracted, the door arm 42 moves so as to be spaced apart from the aperture 10 of the conveying chamber around the fulcrum 41. By this operation, the door 6 pivots together with the lid 4 to remove the lid 4 from the pod. This state is shown in FIG. 7. Thereafter, the moving portion 56 is caused to lower, the lid 4 is conveyed as far as a predetermined shunting position, the wafer is taken out from the pod opened, and various processing is carried out on the wafer in the processing chamber 59. The FIMS system having the door open-close mechanism constructed as described above is used, whereby it becomes possible to perform operations such as taking wafer from the pod in cleaner space.

In this respect, in the above-described embodiment and example, the present invention has been described with the FIMS system as the subject, and the example of application of the present invention is not limited to the system. So long as the system has structure for opening and closing a member such as the door for partitioning between a plurality of space held at pressure different from the ambient pressure, it is possible to apply a load port according to the present invention, that is, the door open-close mechanism.

As many apparently widely different embodiment of the present invention can be made without departing from the spirit and scope thereof, it is to be understood that the invention is not limited to the specific embodiments thereof expected as defined in the claims.

This application claims priority from Japanese Patent Application No. 2004-159199 filed May 28, 2004 which is hereby incorporated by reference herein.

1. A load port for detaching a lid from and attaching to a pod having a main body portion which places an aperture and an object to be housed in parallel in a predetermined direction for housing, and the lid which is separate-able from said main body portion and blocks said aperture, comprising:
a chamber having a first aperture opposite to said aperture;
a door for closing said first aperture, capable of holding said lid; and
a door arm for supporting said door at its one end, being coupled to a drive unit at the other end, and being, at an intermediate portion, rotatively supported by a fixing member,
wherein said drive unit drives said door arm at a predetermined speed during the early stage of driving and drives said door arm at speed faster than said predetermined speed with the exception of during the early stage of driving.

2. The load port according to claim 1, wherein said drive unit is a two-step cylinder.

3. The load port according to claim 2, wherein said two-step cylinder includes:
a cylindrical cylinder chamber;
a piston having a disk-shape coaxial to said cylinder chamber, arranged within said cylinder chamber, for separating said cylinder chamber into a rod-side cylinder chamber and a head-side cylinder chamber;
a through-hole coaxial to said cylinder chamber, and having a smaller inner diameter than that of said cylinder chamber, and a rod-side port, both of which communicate said rod-side cylinder chamber to the outside of said two-step cylinder;
a cylindrical auxiliary chamber coaxial to said cylinder chamber and having a smaller inner diameter than that of said cylinder chamber, and a bypass path provided at a different position from said auxiliary chamber and having a drawing portion therein, both of which communicating to an end portion different from a side, of said head-side cylinder chamber at which said piston is arranged, and communicating to said head-side port for communicating said head-side cylinder chamber to the outside of said two-step cylinder;
a cylinder rod coaxial to said piston, one end of which is supported by said piston, the other end of which extends as far as the outside of said two-step cylinder via said through-hole;
a head portion coaxial to said piston, one end of which is supported on an auxiliary chamber-side surface in said piston, having an enlarged-diameter portion having a smaller outer diameter than an inner diameter of said auxiliary chamber at the other end; and
head-side packing fixed to the inner peripheral surface of said auxiliary chamber in a predetermined position of said cylinder chamber in said auxiliary chamber in an axial direction,
wherein the outer peripheral surface of said enlarged-diameter portion is slidable in a close contact state with said head-side packing, and in said close contact state, said head-side cylinder chamber communicates to said head-side port via only said bypass path.

4. A method for opening a first aperture by a door in a load port for detaching a lid from a pod having a main body portion which places an aperture and an object to be housed in parallel in a predetermined direction for housing, and said lid which is separate-able from said main body portion and blocks said aperture, said load port having said chamber having a first aperture opposite to said aperture; a door for closing said first aperture, capable of holding said lid; and a door arm for supporting said door at one end, being coupled to the drive unit at the other end, and being, at the intermediate portion, rotatively supported by a fixing member, said method comprising the steps of:
driving, during the early stage whereat said door opens said first aperture, said door by said drive unit at a predetermined speed;
driving, after said door is spaced apart by a first predetermined amount from said first aperture, said door by said drive unit at speed faster than said predetermined speed; and
stopping, after said door is spaced apart by a second predetermined amount from said first aperture, the opening of said door by said drive unit; and tab placing said door and said drive unit in a body at an interval from said first aperture.
